(19) United States
(12) Patent Application Publication
(10) Pub. No.: US 2017/0075441 A1
(43) Pub. Date: Mar. 16, 2017

(54) SEMI-PASSIVE STYLUS

(71) Applicant: Tactual Labs Co., New York, NY (US)

(72) Inventors: Darren Leigh, Round Hill, VA (US); Steven Leonard Sanders, New York, NY (US); Clifton Forlines, Toronto (CA)

(73) Assignee: Tactual Labs Co., New York, NY (US)

(21) Appl. No.: 15/263,262

(22) Filed: Sep. 12, 2016

Related U.S. Application Data
(60) Provisional application No. 62/217,426, filed on Sep. 11, 2015.

(51) Int. Cl. G06F 3/0354; G06F 3/044; G06F 3/041

(52) U.S. Cl. CPC G06F 3/03545; G06F 3/0416; G06F 3/044; G06F 2203/04108; G06F 2203/04105; G06F 2203/04104

(57) ABSTRACT

Disclosed are styli having an elongated body for use in connection with a touch-sensitive device, wherein the touch-sensitive device generates touch detection signals proximate to its surface. In an embodiment, the stylus comprises a nib having one or more nib components adapted to interact with the touch detection signals present on the touch surface, and one or more variable circuits operatively connecting the one or more nib components to the stylus body or other source of environmental ground. In an embodiment, the stylus has a nib comprising a plurality of nib components adapted to interact with the touch detection signals present on the touch surface; each of the plurality of nib components are insulated from each other, except for a variable circuit variably connecting at least two of the plurality of nib components. Also disclosed are methods for detecting the position, angle and rotation of the stylus with respect to the touch-sensitive device based on a detected amount of varied electrical connection.

This application is a non-provisional of and claims priority to U.S. Provisional Patent Application No. 62/217,426 entitled “Semi-Passive Stylus Using Parametric Modulation,” filed Sep. 11, 2015.

### FIELD

The disclosed system and method relate in general to the field of user input, and in particular to user input systems which provide a novel semi-passive stylus.

### BRIEF DESCRIPTION OF THE DRAWINGS

The foregoing and other objects, features, and advantages of the disclosure will be apparent from the following more particular description of embodiments as illustrated in the accompanying drawings, in which reference characters refer to the same parts throughout the various views. The drawings are not necessarily to scale, emphasis instead being placed upon illustrating principles of the disclosed embodiments.

FIG. 1 provides a high level block diagram illustrating an embodiment of a low-latency touch sensor device.

FIG. 2A shows an embodiment of a projected capacitive touch surface having rows and columns.

FIG. 2B shows a touch providing coupling between a set of rows and a set of columns.

FIG. 2C shows a stylus or other tangible providing coupling between the rows and columns.

FIGS. 3A-C show illustrative embodiments of capacitance being parametrically modulated in a semi-passive stylus.

FIG. 4A-B show illustrative embodiments of a semi-passive stylus.

FIG. 5A-C shows a further illustrative embodiment of an intermeshed nib of a stylus.

FIGS. 6A-C show illustrative embodiments of capacitance being parametrically modulated in an intermeshed nib of a stylus.

FIG. 7A shows another illustrative embodiment of a stylus with its nib divided into three different capacitive sections and shown in three different orientations (left, center, and right) in relation to the touch surface. FIG. 7B shows levels of modulation for the left, center, and right stylus positions previously shown in FIG. 7A.

### BACKGROUND

A stylus or tangible object (hereinafter, sometimes, a tangible) can work in three different ways: (1) passive, in which the stylus has no battery or other power source at all and relies on the energy of external signals to perform its function; (2) active, in which the stylus has its own power source that is used to run both internal electronics and transmit signals; and (3) as disclosed herein, semi-passive, in which the stylus has its own battery or power source that is used to run internal electronics, but is not used to generate or transmit signals.

Existing active projected capacitive (PCAP) styli are expensive, heavy, and thick-bodied, human-interface devices due to their high active power and reliance on an array of heterogeneous digital, analog, and mechanical sensors to collect input data and context. Their high active power can also result in a direct cause of inconvenience for end-users requiring periodic recharging or battery replacement to ensure continuous operation. These limitations have slowed the widespread commercial adoption of active PCAP styli. However, these compromises enable a computer system connected to an active PCAP stylus to provide: input discrimination between styli events and touches; input discrimination between multiple active styli; discrimination between the nib and eraser of one or more active styli; superior palm rejection; and a thin stylus nib.

While, an active stylus can be designed to be distinguished from other touches and styli, it expends a significant amount of power in doing so. Thus, an active stylus generally requires a large battery and/or one that must frequently be recharged and/or replaced.

Passive (i.e., battery-free) PCAP styli resolve these cost and power limitations by forgoing the ability to reliably discriminate between simultaneous styli nib, styli eraser, and touch input. Passive styli also partially resolve the ergonomic limitations of active pens by eliminating the need for a battery and complex enabling components. However, while the passive stylus design simplification streamlines and thins the stylus's body, it does so at the expense of input signal-to-noise ratio, thereby compromising nib thickness, and effectively trading one ergonomic deficit for another. A passive stylus may be a conductive or dielectric rod, e.g., used to mimic a human finger, and a number of passive styli are sold for use with extant COTS tablet computers. A problem with passive styli, however, is that their inputs cannot be distinguished from other passive styli or from touches.

As compared to today's active and passive styli, the semi-passive stylus disclosed herein achieves lower power consumption, maintains design complexity, and lessens associated costs as compared to passive and active styli. The presently disclosed semi-passive stylus may provide some or all of these advantages without compromising on required or beneficial stylus properties. The stylus also requires little power, and nib thickness is not spared to accommodate the benefits disclosed herein. For example, in an embodiment, a small battery might last for years or even the lifetime of the device due to the semi-passive stylus's limited power consumption. Further, the disclosed semi-passive stylus permits input discrimination between styli events and touches, input discrimination between multiple styli, discrimination between the nib and eraser of one or more active styli, and palm rejection (which is used to prevent unintended touch inputs). Thus, the semi-passive stylus, as disclosed herein, overcomes the drawbacks associated with active and passive styli and can be designed to be distinguishable from other styli and from fingers.

### DETAILED DESCRIPTION

In various embodiments, including those illustrated herein, the present disclosure is directed to touch-sensitive objects and methods for designing, manufacturing and their operation. Although example compositions or geometries are disclosed for the purpose of illustrating the invention, other compositions and geometries will be apparent to a person of skill in the art, in view of this disclosure, without departing from the scope and spirit of the disclosure herein.

This application relates to user interfaces such as the fast multi-touch sensors and other interfaces as disclosed in U.S. patent application Ser. No. 14/993,868 filed on Jan. 12, 2016, entitled “Fast Multi-Touch Stylus and Sensor.” The entire disclosure of which is herein incorporated by reference.

Throughout this disclosure, the terms “hover”, “touch”, “touches,” “contact”, “contacts,” “pressure,” or “pressures” or other descriptors may be used to describe events or periods of time in which a user's finger, a stylus, an object or a body part is detected by the sensor. In some embodiments, and as generally denoted by the word “contact,” these detections occur only when the user is in physical contact with a sensor, or a device in which it is embodied. In other embodiments, and as generally referred to by the term “hover,” the sensor may be tuned to allow the detection of “touches” or “contacts” that are hovering a distance above the touch surface or otherwise separated from the touch-sensitive device. As used herein, “touch surface” may or may not have actual features, and could be a generally feature-sparse surface. The use of language within this description that implies reliance upon sensed physical contact should not be taken to mean that the techniques described apply only to those embodiments; indeed, generally, what is described herein applies equally to “contact” and “hover,” each of which being a “touch,” as that term is used herein. More generally, as used herein, the term “touch” refers to an act that can be detected by the types of sensors disclosed herein, thus, as used herein the term “hover” is but one type of “touch” in the sense that “touch” is intended herein. “Pressure” refers to a force with which a user presses their fingers or hand (or another object such as a stylus) against the surface of a touch-sensitive object. The amount of “pressure” is may be a measure of “contact”, i.e., touch area, or as described, may be a measure otherwise related to the pressure of a touch. Touch refers to the states of “hover”, “contact” “pressure” or “grip”, whereas a lack of “touch” is generally identified by changes in signals being outside the threshold for accurate measurement by the sensor. Other types of sensors may be utilized in connection with the embodiments disclosed herein, including a camera, a proximity sensor, an optical sensor, a turn-rate sensor, a gyroscope, a magnetometer, a thermal sensor, a pressure sensor, a capacitive sensor, a power-management integrated circuit reading, a motion sensor, and the like.

As used herein, and including within the claims, ordinal terms such as first and second are not intended, in and of themselves, to imply sequence, time or uniqueness, but rather, are used to distinguish one construct, e.g., one claimed construct from another. In some uses where the context dictates, these terms may imply that the first and second are unique. For example, where an event occurs at a first time, and another event occurs at a second time, there is no intended implication that the first time occurs before the second time. However, where the further limitation that the second time is after the first time is presented in the claim, the context would require reading the first time and the second time to be unique times. Similarly, where the context so dictates or permits, ordinal terms are intended to be broadly construed so that the two identified claim constructs can be of the same characteristic or of different characteristic. Thus, for example, a first and a second frequency, absent further limitation, could be the same frequency—e.g., the first frequency being 10 Mhz and the second frequency being 10 Mhz; or could be different frequencies—e.g., the first frequency being 10 Mhz and the second frequency being 11 Mhz. Context may dictate otherwise, for example, where a first and a second frequency are further limited to being orthogonal to each other, in which case, they could not be the same frequency.

The presently disclosed systems and methods provide for designing, manufacturing and using capacitive touch sensors, and including capacitive touch sensors that employ a multiplexing scheme based on orthogonal signaling such as but not limited to frequency-division multiplexing (FDM), code-division multiplexing (CDM), or a hybrid modulation technique that combines both FDM and CDM methods. References to frequency herein could also refer to other orthogonal signal bases. Capacitive FDM, CDM, or FDM/CDM hybrid touch sensors may be used in connection with the presently disclosed sensors. In such sensors, touches may be sensed when a signal from a row is coupled (increased) or decoupled (decreased) to a column and the result received on that column.

This disclosure will first describe the operation of certain fast multi-touch sensors which may be used in connection with the touch-sensitive objects described herein, or to implement the present systems and methods for design, manufacturing and operation thereof. Details of the presently disclosed semi-passive stylus are described below under the heading “Semi-Passive Stylus.”

As used herein, the phrase “touch event” and the word “touch” when used as a noun include a near touch and a near touch event, or any other gesture that can be identified using a sensor. In accordance with an embodiment, touch events may be detected, processed and supplied to downstream computational processes with very low latency, e.g., on the order of ten milliseconds or less, or on the order of less than one millisecond.

In an embodiment, the disclosed fast multi-touch sensor utilizes a projected capacitive method that has been enhanced for high update rate and low latency measurements of touch events. The technique can use parallel hardware and higher frequency waveforms to gain the above advantages. In an embodiment, disclosed methods and apparatus can be used to make sensitive and robust measurements, which methods may be used on transparent display surfaces and which may permit economical manufacturing of products which employ the technique. In this regard, a “capacitive object” as used herein could be a finger, other part of the human body, a stylus, or any object to which the sensor is sensitive. The sensors and methods disclosed herein need not rely on capacitance. With respect to, e.g., an optical sensor, an embodiment utilizes photon tunneling and leaking to sense a touch event, and a “capacitive object” as used herein includes any object, such as a stylus or finger, that that is compatible with such sensing. Similarly, “touch locations” and “touch-sensitive device” as used herein do not require actual touching contact between a capacitive object and the disclosed sensor.

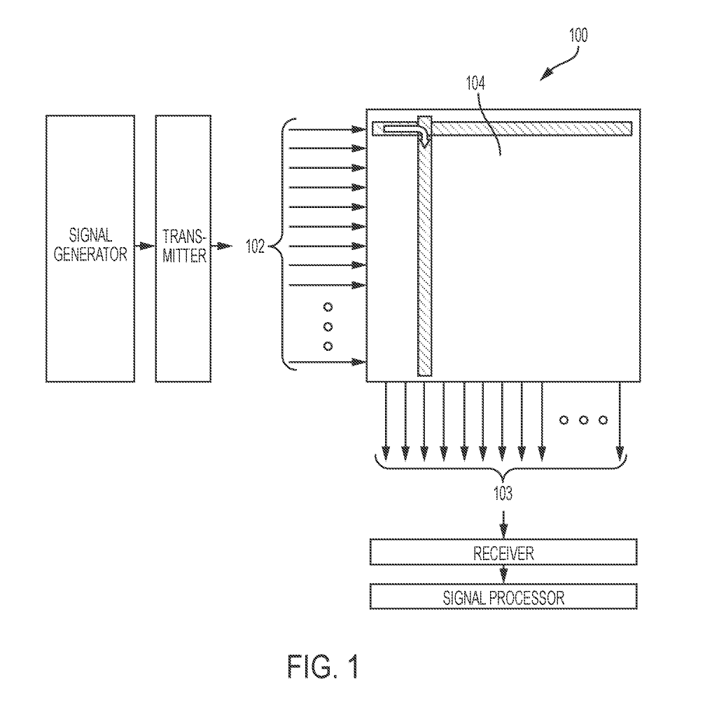

FIG. 1 illustrates certain principles of a fast multi-touch sensor 100 in accordance with an embodiment. At reference no. 102, differing signals are simultaneously transmitted into a plurality of rows. The differing signals are “orthogonal”, i.e., separable and distinguishable from each other. At reference no. 103, a receiver is attached to each column. The receiver is designed to receive any of the transmitted signals, or an arbitrary combination of them, with or without other signals and/or noise, and to individually determine at least one measure, e.g., a quantity, for each of the simultaneously transmitted signals present on each of the columns. The touch surface 104 of the sensor comprises a series of rows and columns (not all shown), along which the orthogonal signals can propagate. In an embodiment, the rows and columns may be designed so that, when they are not subject to a touch event, a lower or negligible amount of signal is coupled between them, whereas, when they are subject to a touch event, a higher or non-negligible amount of signal is coupled between them. In an embodiment, the opposite could hold—having the lesser amount of signal represent a touch event, and the greater amount of signal represent a lack of touch. Because the touch sensor ultimately detects touch due to a change in the coupling, it is not of specific importance, except for reasons that may otherwise be apparent to a particular embodiment, whether the touch-related coupling causes an increase in amount of row signal present on the column or a decrease in the amount of row signal present on the column. As discussed above, the touch, or touch event does not require a physical touching, provided that the touch is an event that affects the level of coupled signal.

With continued reference to FIG. 1, in an embodiment, generally, the capacitive result of a touch event in the proximity of both a row and column may cause a non-negligible change in the amount of signal present on the row to be coupled to the column. More generally, touch events cause, and thus correspond to, the received signals on the columns. Because the signals on the rows are orthogonal, multiple row signals can be coupled to a column and distinguished by the receiver. Likewise, the signals on each row can be coupled to multiple columns. For each column coupled to a given row (and regardless of whether the coupling causes an increase or decrease in the row signal to be present on the column), the signals found on the column contain information that will indicate which rows are being touched in proximity with that column. The quantity of each signal received is generally related to the amount of coupling between the column and the row carrying the corresponding signal, and thus, may indicate a distance of the touching object to the surface, an area of the surface covered by the touch and/or the pressure of the touch.

When a touch occurs in proximity to a given row and column, the level of the signal that is present on the row is changed in the corresponding column (the coupling may cause an increase or decrease of the row signal on the column). (As discussed above, the term touch or touched does not require actual physical contact, but rather, relative proximity). Indeed, in various implementations of a touch device, physical contact with the rows and/or columns is unlikely as there may be a protective barrier between the rows and/or columns and the finger or other object of touch. Moreover, generally, the rows and columns themselves are not in touch with each other, but rather, placed in a proximity that allows an amount of signal to be coupled there-between and that amount changes (increases or decreases) with touch. Generally, the row-column coupling results not from actual contact between them, nor by actual contact from the finger or other object of touch, but rather, by the capacitive effect of bringing the finger (or other object) into proximity—which proximity resulting in capacitive effect is referred to herein as touch).

The nature of the rows and columns is arbitrary and the particular orientation is irrelevant. Indeed, the terms row and column are not intended to refer to a square grid, but rather to conductors upon which signal is transmitted (rows) and conductors onto which signal may be coupled (columns). (The notion that signals are transmitted on rows and received on columns itself is arbitrary, and signals could as easily be transmitted on conductors arbitrarily designated columns and received on conductors arbitrarily named rows, or both could arbitrarily be named something else). Further, it is not necessary that the rows and columns be in a grid. As described herein, other shapes and orientations are possible. Provided that a touch event will affect the intersection of a “row” and a “column”, and cause some change in coupling between them. For example, in two dimensions, the “rows” could be in concentric circles and the “columns” could be spokes radiating out from the center. And neither the “rows” nor the “columns” need to follow any geometric or spatial pattern, thus, for example, transmit and receive antennae could be arbitrarily connected to form rows and columns (related or unrelated to their relative positions.) Moreover, it is not necessary for there to be only two types of signal propagation channels: instead of rows and columns, in an embodiment, channels “A”, “B” and “C” may be provided, and signals transmitted on “A” could be received on “B” and “C”, or, in an embodiment, signals transmitted on “A” and “B” could be received on “C”. It is also possible that the signal propagation channels can alternate function, at different times supporting transmitters and receivers. It is also contemplated that the signal propagation channels can simultaneously support transmitters and receivers—provided that the signals transmitted are separable, from the signals received. Many alternative embodiments are possible and will be apparent to a person of skill in the art in view of this disclosure.

As noted above, in an embodiment the touch surface 104 comprises of a series of rows and columns, along which signals can propagate. As discussed above, the rows and columns are designed so that, when they are not being touched, one amount of signal is coupled between them, and when they are being touched, another amount of signal is coupled between them. The change in signal coupled between them may be generally proportional or inversely proportional (although not necessarily linearly proportional) to the touch such that touch is not so much a yes-no question, but rather more of a gradation, permitting distinction between touches, e.g., more touch (i.e., closer or firmer) and less touch (i.e., farther or softer)—and even no touch. When a touch occurs in proximity to a row/column crossing, the signal that is present on the column is changed (positively or negatively). The quantity of the signal that is coupled onto a column may be related to the proximity, pressure or area of touch.

A receiver is attached to each column. The receiver is designed to receive the signals present on each column, including any of the orthogonal signals, or an arbitrary combination of the orthogonal signals, and any noise or other signals present. Generally, the receiver is designed to receive a frame of signals present on the columns, and to quantify each of the row signals present in that frame. In an embodiment, the frame is captured by an ADC on each column, and the time-domain data captured by the ADC is converted into frequency domain data reflective with “buckets” for each different frequency that is transmitted on a row. In an embodiment, the receiver (or a signal processor associated with the receiver data) may determine a measure associated with the quantity of each of the orthogonal transmitted signals present on that column during the time the frame of signals was captured. In this manner, in addition to identifying the rows in touch with each column, the receiver can provide additional (e.g., qualitative) information concerning the touch. In general, touch events may correspond (or inversely correspond) to the received signals on the columns. In an embodiment, for each column, the different signals received thereon indicate which of the corresponding rows are being touched in proximity with that column. In an embodiment, the amount of coupling between the corresponding row and column may indicate, e.g., the area of the surface covered by the touch, the pressure of the touch, etc. In an embodiment, a change in coupling over time between the corresponding row and column indicates a change in touch at the intersection of the two.

### Sinusoid Illustration

In an embodiment, the orthogonal signals being transmitted onto the rows may be unmodulated sinusoids, each having a different frequency, the frequencies being chosen so that they can be distinguished from each other in the receiver. In an embodiment, frequencies are selected to provide sufficient spacing between them such that they can be more easily distinguished from each other in the receiver. In an embodiment, frequencies are selected such that no simple harmonic relationships exist between the selected frequencies. The lack of simple harmonic relationships may mitigate non-linear artifacts that can cause one signal to mimic another.

Generally, a “comb” of frequencies, where the spacing between adjacent frequencies is constant, and the highest frequency is less than twice the lowest, will meet these criteria if the spacing between frequencies, Δf, is at least the reciprocal of the measurement period τ. For example, if it is desired to measure a combination of signals (from a column, for example) to determine which row signals are present once per millisecond (τ), then the frequency spacing (Δf) must be greater than one kilohertz (i.e., Δf>1/τ). According to this calculation, in an example case with ten rows, one could use the following frequencies:
Row 1: 5.000 MHz Row 6: 5.005 MHz
Row 2: 5.001 MHz Row 7: 5.006 MHz
Row 3: 5.002 MHz Row 8: 5.007 MHz
Row 4: 5.003 MHz Row 9: 5.008 MHz
Row 5: 5.004 MHz Row 10: 5.009 MHz

It will be apparent to one of skill in the art in view of this disclosure that frequency spacing may be substantially greater than this minimum to permit robust design. As an example, a 20 cm by 20 cm touch surface with 0.5 cm row/column spacing may require forty rows and forty columns and necessitate sinusoids at forty different frequencies. While a once per millisecond analysis rate would require only 1 KHz spacing, an arbitrarily larger spacing is utilized for a more robust implementation. In an embodiment, the arbitrarily larger spacing is subject to the constraint that the maximum frequency should not be more than twice the lowest (i.e., fₘₐₓ<2(fₘᵢₙ₎). Thus, in this example, a frequency spacing of 100 kHz with the lowest frequency set at 5 MHz may be used, yielding a frequency list of 5.0 MHz, 5.1 MHz, 5.2 MHz, etc. up to 8.9 MHz.

In an embodiment, each of the sinusoids on the list may be generated by a signal generator and transmitted on a separate row by a signal emitter or transmitter. To identify the rows and columns proximate to a touch, a receiver receives a frame of signals present on the columns and a signal processor analyzes the signal to determine which, if any, frequencies on the list appear. In an embodiment, the identification can be supported with a frequency analysis technique (e.g., Fourier transform), or by using a filter bank. In an embodiment, the receiver receives a frame of column signals, which frame is processed through an FFT, and thus, a measure is determined for each frequency. In an embodiment, the FFT provides an in-phase and quadrature measure for each frequency, for each frame.

In an embodiment, from each column's signal, the receiver/signal processor can determine a value (and in an embodiment an in-phase and quadrature value) for each frequency from the list of frequencies found in the signal on that column. In an embodiment, where the value corresponding to a frequency is greater or lower than some threshold, or changes from a prior value, that information is used to identify a touch event between the column and the row corresponding to that frequency. In an embodiment, signal strength information, which may correspond to various physical phenomena including the distance of the touch from the row/column intersection, the size of the touch object, the pressure with which the object is pressing down, the fraction of row/column intersection that is being touched, etc. may be used as an aid to localize the area of the touch event. In an embodiment, the determined values are not self-determinative of touch, but rather are further processed along with other values to determine touch events.

Once values for each of the orthogonal frequencies, have been determined for at least a plurality of frequencies (each corresponding to a row) or for at least a plurality of columns, a two-dimensional map can be created, with the value being used as, or proportional/inversely proportional to, a value of the map at that row/column intersection. In an embodiment, values are determined at multiple row/column intersections on a touch surface to produce a map for the touch surface or region. In an embodiment, values are determined for every row/column intersection on a touch surface, or in a region of a touch surface, to produce a map for the touch surface or region. In an embodiment, the signals' values are calculated for each frequency on each column. Once signal values are calculated a two-dimensional or three-dimensional map may be created. In an embodiment, the signal value is the value of the map at that row/column intersection. In an embodiment, the signal value is processed to reduce noise before being used as the value of the map at that row/column intersection. In an embodiment, another value proportional, inversely proportional or otherwise related to the signal value (either after being processed to reduce noise) is employed as the value of the map at that row/column intersection. In an embodiment, due to physical differences in the touch surface at different frequencies, the signal values are normalized for a given touch or calibrated. Similarly, in an embodiment, due to physical differences across the touch surface or between the intersections, the signal values need to be normalized for a given touch or calibrated.

In an embodiment, the map data may be thresholded to better identify, determine or isolate touch events. In an embodiment, the map data is used to infer information about the shape, orientation, etc. of the object touching the surface.

In an embodiment, such analysis and any touch processing described herein may be performed on a touch sensor's discrete touch controller. In another embodiment, such analysis and touch processing may be performed on other computer system components such as but not limited to one or more ASIC, MCU, FPGA, CPU, GPU, SoC, DSP or dedicated circuit. The term “hardware processor” as used herein means any of the above devices or any other device which performs computational functions.

Returning to the discussion of the signals being transmitted on the rows, a sinusoid is not the only orthogonal signal that can be used in the configuration described above. Indeed, as discussed above, any set of signals that can be distinguished from each other will work. Nonetheless, sinusoids may have some advantageous properties that may permit simpler engineering and more cost efficient manufacture of devices which use this technique. For example, sinusoids have a very narrow frequency profile (by definition), and need not extend down to low frequencies, near DC. Moreover, sinusoids can be relatively unaffected by 1/f noise, which noise could affect broader signals that extend to lower frequencies.

In an embodiment, sinusoids may be detected by a filter bank. In an embodiment, sinusoids may be detected by frequency analysis techniques (e.g., Fourier transform/fast Fourier transform). Frequency analysis techniques may be implemented in a relatively efficient manner and may tend to have good dynamic range characteristics, allowing them to detect and distinguish between a large number of simultaneous sinusoids. In broad signal processing terms, the receiver's decoding of multiple sinusoids may be thought of as a form of frequency-division multiplexing. In an embodiment, other modulation techniques such as time-division and code-division multiplexing could also be used. Time division multiplexing has good dynamic range characteristics, but typically requires that a finite time be expended transmitting into (or analyzing received signals from) the touch surface. Code division multiplexing has the same simultaneous nature as frequency-division multiplexing, but may encounter dynamic range problems and may not distinguish as easily between multiple simultaneous signals.

### Modulated Sinusoid Illustration

In an embodiment, a modulated sinusoid may be used in lieu of, in combination with and/or as an enhancement of, the sinusoid embodiment described above. The use of unmodulated sinusoids may cause radiofrequency interference to other devices near the touch surface, and thus, a device employing them might encounter problems passing regulatory testing (e.g., FCC, CE). In addition, the use of unmodulated sinusoids may be susceptible to interference from other sinusoids in the environment, whether from deliberate transmitters or from other interfering devices (perhaps even another identical touch surface). In an embodiment, such interference may cause false or degraded touch measurements in the described device.

In an embodiment, to avoid interference, the sinusoids may be modulated or “stirred” prior to being transmitted by the transmitter in a manner that the signals can be demodulated (“unstirred”) once they reach the receiver. In an embodiment, an invertible transformation (or nearly invertible transformation) may be used to modulate the signals such that the transformation can be compensated for and the signals substantially restored once they reach the receiver. As will also be apparent to one of skill in the art, signals emitted or received using a modulation technique in a touch device as described herein will be less correlated with other things, and thus, act more like mere noise, rather than appearing to be similar to, and/or being subject to interference from, other signals present in the environment.

### Frequency Modulation

Frequency modulation of the entire set of sinusoids keeps them from appearing at the same frequencies by “smearing them out.” Because regulatory testing is generally concerned with fixed frequencies, transmitted sinusoids that are frequency modulated will appear at lower amplitudes, and thus be less likely to be a concern. Because the receiver will “un-smear” any sinusoid input to it, in an equal and opposite fashion, the deliberately modulated, transmitted sinusoids can be demodulated and will thereafter appear substantially as they did prior to modulation. Any fixed frequency sinusoids that enter (e.g., interfere) from the environment, however, will be “smeared” by the “unsmearing” operation, and thus, will have a reduced or an eliminated effect on the intended signal. Accordingly, interference that might otherwise be caused to the sensor is lessened by employing frequency modulation, e.g., to a comb of frequencies that, in an embodiment, are used in the touch sensor.

In an embodiment, the entire set of sinusoids may be frequency modulated by generating them all from a single reference frequency that is, itself, modulated. For example, a set of sinusoids with 100 kHz spacing can be generated by multiplying the same 100 kHz reference frequency by different integers. In an embodiment, this technique can be accomplished using phase-locked loops. To generate the first 5.0 MHz sinusoid, one could multiply the reference by 50, to generate the 5.1 MHz sinusoid, one could multiply the reference by 51, and so forth. The receiver can use the same modulated reference to perform the detection and demodulation functions.

### Direct Sequence Spread Spectrum Modulation

In an embodiment, the sinusoids may be modulated by periodically inverting them on a pseudo-random (or even truly random) schedule known to both the transmitter and receiver. Thus, in an embodiment, before each sinusoid is transmitted to its corresponding row, it is passed through a selectable inverter circuit, the output of which is the input signal multiplied by +1 or −1 depending on the state of an “invert selection” input. In an embodiment, all of these “invert selection” inputs are driven from the same signal, so that the sinusoids for each row are all multiplied by either +1 or −1 at the same time. In an embodiment, the signal that drives the “invert selection” input may be a pseudorandom function that is independent of any signals or functions that might be present in the environment. The pseudorandom inversion of the sinusoids spreads them out in frequency, causing them to appear like random noise so that they interfere negligibly with any devices with which they might come in contact.

On the receiver side, the signals from the columns may be passed through selectable inverter circuits that are driven by the same pseudorandom signal as the ones on the rows. The result is that, even though the transmitted signals have been spread in frequency, they are despread before the receiver because they have been ben multiplied by either +1 or −1 twice, leaving them in, or returning them to, their unmodified state. Applying direct sequence spread spectrum modulation may spread out any interfering signals present on the columns so that they act only as noise and do not mimic any of the set of intentional sinusoids.

In an embodiment, selectable inverters can be created from a small number of simple components and/or can be implemented in transistors in a VLSI process.

Because many modulation techniques are independent of each other, in an embodiment, multiple modulation techniques could be employed at the same time, e.g., frequency modulation and direct sequence spread spectrum modulation of the sinusoid set. Although potentially more complicated to implement, such multiple modulated implementation may achieve better interference resistance.

Because it would be extremely rare to encounter a particular pseudo random modulation in the environment, it is likely that the multi-touch sensors described herein would not require a truly random modulation schedule. One exception may be where more than one touch surface with the same implementation is being touched by the same person. In such a case, it may be possible for the surfaces to interfere with each other, even if they use very complicated pseudo random schedules. Thus, in an embodiment, care is taken to design pseudo random schedules that are unlikely to conflict. In an embodiment, some true randomness may be introduced into the modulation schedule. In an embodiment, randomness is introduced by seeding the pseudo random generator from a truly random source and ensuring that it has a sufficiently long output duration (before it repeats). Such an embodiment makes it highly unlikely that two touch surfaces will ever be using the same portion of the sequence at the same time. In an embodiment, randomness is introduced by exclusive or'ing (XOR) the pseudo random sequence with a truly random sequence. The XOR function combines the entropy of its inputs, so that the entropy of its output is never less than either input.

### Sinusoid Detection

In an embodiment, sinusoids may be detected in a receiver using a complete radio receiver with a Fourier Transform detection scheme. Such detection may require digitizing a high-speed RF waveform and performing digital signal processing thereupon. Separate digitization and signal processing may be implemented for every column of the surface; this permits the signal processor to discover which of the row signals are in touch with that column. In the above-noted example, having a touch surface with forty rows and forty columns, would require forty copies of this signal chain. Today, digitization and digital signal processing are relatively expensive operations, in terms of hardware, cost, and power. It would be useful to utilize a more cost-effective method of detecting sinusoids, especially one that could be easily replicated and requires very little power.

In an embodiment, sinusoids may be detected using a filter bank. A filter bank comprises an array of bandpass filters that can take an input signal and break it up into the frequency components associated with each filter. The Discrete Fourier Transform (DFT, of which the FFT is an efficient implementation) is a form of a filter bank with evenly-spaced bandpass filters that may be used for frequency analysis. DFTs may be implemented digitally, but the digitization step may be expensive. It is possible to implement a filter bank out of individual filters, such as passive LC (inductor and capacitor) or RC active filters. Inductors are difficult to implement well on VLSI processes, and discrete inductors are large and expensive, so it may not be cost effective to use inductors in the filter bank.

At lower frequencies (about 10 MHz and below), it is possible to build banks of RC active filters on VLSI. Such active filters may perform well, but may also take up a lot of die space and require more power than is desirable.

At higher frequencies, it is possible to build filter banks with surface acoustic wave (SAW) filter techniques. These allow nearly arbitrary FIR filter geometries. SAW filter techniques require piezoelectric materials which are more expensive than straight CMOS VLSI. Moreover, SAW filter techniques may not allow enough simultaneous taps to integrate sufficiently many filters into a single package, thereby raising the manufacturing cost.

In an embodiment, sinusoids may be detected using an analog filter bank implemented with switched capacitor techniques on standard CMOS VLSI processes that employs an FFT-like “butterfly” topology. The die area required for such an implementation is typically a function of the square of the number of channels, meaning that a 64-channel filter bank using the same technology would require only 1/256th of the die area of the 1024-channel version. In an embodiment, the complete receive system for the low-latency touch sensor is implemented on a plurality of VLSI dies, including an appropriate set of filter banks and the appropriate amplifiers, switches, energy detectors, etc. In an embodiment, the complete receive system for the low-latency touch sensor is implemented on a single VLSI die, including an appropriate set of filter banks and the appropriate amplifiers, switches, energy detectors, etc. In an embodiment, the complete receive system for the low-latency touch sensor is implemented on a single VLSI die containing n instances of an n-channel filter bank, and leaving room for the appropriate amplifiers, switches, energy detectors, etc.

### Sinusoid Generation

Generating the transmit signals (e.g., sinusoids) in a low-latency touch sensor is generally less complex than detection, principally because each row requires the generation of a single signal while the column receivers have to detect and distinguish between many signals. In an embodiment, sinusoids can be generated with a series of phase-locked loops (PLLs), each of which multiply a common reference frequency by a different multiple.

In an embodiment, the low-latency touch sensor design does not require that the transmitted sinusoids are of very high quality, but rather, may accommodate transmitted sinusoids that have more phase noise, frequency variation (over time, temperature, etc.), harmonic distortion and other imperfections than may usually be allowable or desirable in radio circuits. In an embodiment, the large number of frequencies may be generated by digital means and then employ a relatively coarse digital-to-analog conversion process. As discussed above, in an embodiment, the generated row frequencies should have no simple harmonic relationships with each other, any non-linearities in the described generation process should not cause one signal in the set to “alias” or mimic another.

In an embodiment, a frequency comb may be generated by having a train of narrow pulses filtered by a filter bank, each filter in the bank outputting the signals for transmission on a row. The frequency “comb” is produced by a filter bank that may be identical to a filter bank that can be used by the receiver. As an example, in an embodiment, a 10 nanosecond pulse repeated at a rate of 100 kHz is passed into the filter bank that is designed to separate a comb of frequency components starting at 5 MHz, and separated by 100 kHz. The pulse train as defined would have frequency components from 100 kHz through the tens of MHz, and thus, would have a signal for every row in the transmitter. Thus, if the pulse train were passed through an identical filter bank to the one described above to detect sinusoids in the received column signals, then the filter bank outputs will each contain a single sinusoid that can be transmitted onto a row.

### Semi-Passive Stylus

The semi-passive stylus disclosed herein achieves lower power consumption, maintains design complexity, and lessens associated costs as compared to passive and active styli. The disclosed semi-passive stylus permits input discrimination between styli events and touches, input discrimination between multiple styli, discrimination between the nib and eraser of one or more styli, and palm rejection (which is used to prevent unintended touch inputs) by utilizing a modulation component such as a variable circuit. The stylus's modulation component parametrically modulates a signal. In an embodiment, the stylus interacts with the ordinary sensor signals to permit detection of its position, and, optionally, its tilt angle and/or angle of rotation. In an embodiment sensor hardware as described above may be used with the semi-passive stylus described herein. The stylus is provided with a nib that can interact with the signals used for touch detection when in proximity to the touch-sensitive device. In an embodiment, the stylus is provided with a nib that itself comprises a plurality of electrically isolated portions that each separately may interact with the signals used for touch detection when in proximity to the touch-sensitive device. In an embodiment, the plurality of electrically isolated portions supports the discrimination of tilt angles and rotation. In an embodiment, differing styli will use differing modulation, thus permitting ready identification between styli. In an embodiment, a switch or other control on the stylus permits selection of a differing modulation scheme, and thus, permits one stylus to have separate identities, for example, such as “black,” “red,” “blue” and “green” ink identities, as in the commonly known four-colored pen. In an embodiment, the stylus may be provided multiple nibs, such as a pen nib on one end, and an eraser nib on the other end.

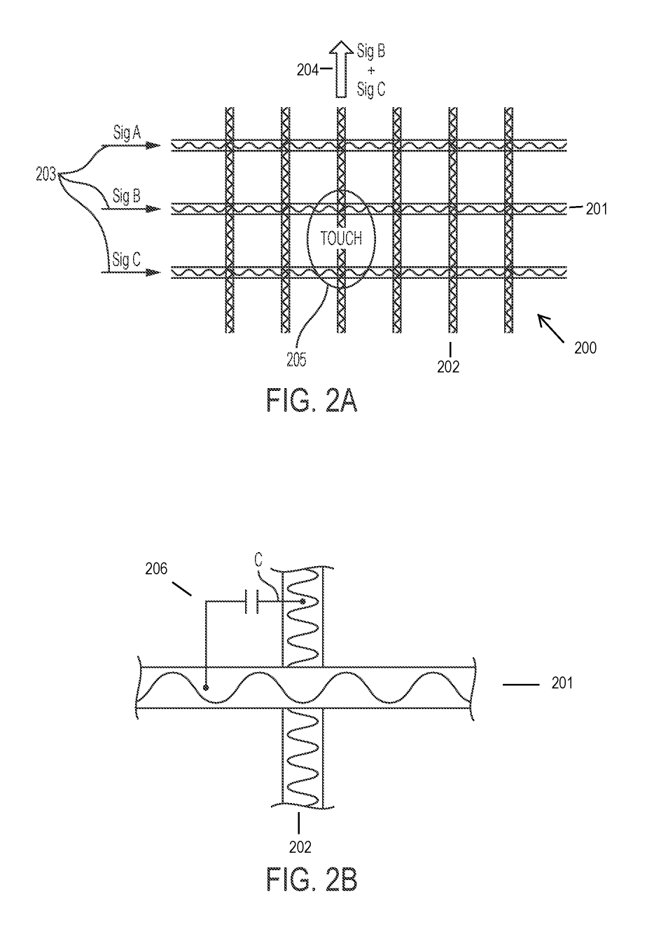

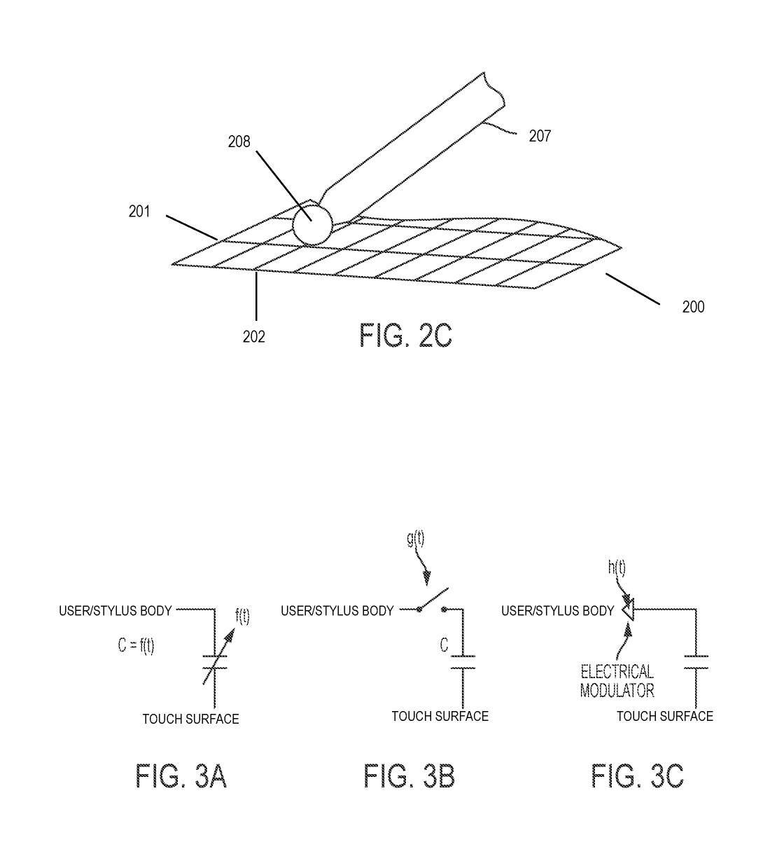

As disclosed above, rows 201 and columns 202 from an exemplary PCAP touch surface 200 are shown in FIG. 2A. The PCAP sensor includes a grid of such rows 201 and columns 202. Signals 203 transmitted on the rows 201 couple to the columns 202. When an object 205 (e.g., a finger, stylus or tangible) touches (e.g., approaches or contacts) a touch surface proximate to their intersection, the coupling of the signals 203 on the columns 202 changes. In an embodiment, the object 205 is conductive or highly dielectric. In different embodiments, the signals may be capacitively coupled toward an environmental ground and away from the column receivers. Where there is residual electrical signal between each row and column, the signal is changed (e.g., reduced) when a row/column intersection is touched. (Although the signals 203, 204 are “illustrated,” the illustration is not intended to represent any particular type of signal. As discussed elsewhere, generally, signals 203 may be orthogonal to each other and signals 204 may comprise some arbitrary combination of the signals 203.)

As further shown in FIG. 2B, a touch provides a change in coupling 206 between a row 201 and a column 202. The signals received 204 on a column 202 can be used to determine changes in coupling between the rows and the column. By analyzing changes in coupling between rows and columns, the location on the touch surface where the coupling is changing can be determined.

Similarly, FIG. 2C shows how an exemplary stylus 207 and its associated nib 208 may be used to create a change in coupling between rows 201 and columns 202 on a touch-sensitive device 200.

In order to distinguish one touching object from another, either new signals are generated that can be received on the columns (or rows), or the touching object may alter or modulate the signals that are coupled from rows to columns. The former is typically performed by active styli, and the latter is performed by the presently disclosed semi-passive stylus.

In an embodiment, a small amount of power (from, e.g., a battery or power source) from the semi-passive stylus may be used to alter the signals “passed through” the stylus (or other tangible). As a result, in an embodiment, the position of the stylus, and potentially ID information, as well as tilt and rotation information, with respect to a touch-sensitive device can be determined. In an embodiment, a plurality of orthogonal row signals are emitted on a respective one of at least some of the plurality of row conductors of the touch-sensitive device. When the stylus is placed in proximity to the touch-sensitive device, it may interact with the signal coupled between at least one of the plurality of row conductors and at least one of the plurality of column conductors of the touch-sensitive device. The modulating component or variable circuit modulates (i.e., varies the electrical connection) between the stylus's nib and the stylus's elongated body or another conductive portion of the stylus that is in conductive contact with a user's hand. The touch-sensitive device can detect the modulated signal to detect an identity, a position, angular position and/or rotation of the stylus with respect to the touch-sensitive device.

FIGS. 3A-C show three exemplary embodiments through which the stylus can interact with the touch detection signals of the touch sensitive device. FIGS. 3A-C show a variable circuit between a nib and a stylus body, which results in variably coupling the nib to the user's hand, and thus, potentially to an environmental ground.

FIG. 3A shows that, in an embodiment, by altering the value of a parameter as a function of time, the coupled signal can be modulated between the nib component and the stylus's body to produce frequency components that were not present in the original signal. In an embodiment, coupling is the parameter. In an embodiment, the parameter is capacitance, because the amount of signal coupled from the user/stylus body to the touch surface is roughly proportional to the capacitance, modulating the capacitance effectively modulates the amplitude of the coupled signal. In an embodiment, capacitance is modulated as a sinusoid of frequency Fₘ, thus, sidebands are added to the original coupled signal that are +Fₘ and −Fₘ away in frequency; such sidebands can be detected by hardware, firmware, or software in the touch sensitive device. In an embodiment, the sidebands identify the touch as being generated by a stylus/tangible that is modulating with frequency Fₘ. In an embodiment, different styli/tangibles can be identified by their different modulation waveforms. As further depicted in FIG. 3A, the modulation could, e.g., be in amplitude, frequency, phase, code, time, etc., or any combination of these.

In an embodiment as shown in FIG. 3B, a stylus's or tangible's coupling (or a portion thereof) can be parametrically modulated through a nib component to the touch panel by using, e.g., an on and off switch. The use of the switch thereby creates a square-wave (or approximates a square wave) of amplitude modulation on the coupled stylus's or tangible's signal. The use of the switch may thereby create frequency sidebands that can be used to distinguish a given stylus or tangible from another stylus or tangible and/or from a touch. Different embodiments can change in and out either series or parallel coupling capacitances. A switch, which could be any kind of a switch, including, e.g., proximity detector or pressure sensor, in the nib of the stylus can be used to control when the modulation device is on or off. The stylus can then be configured such that, under normal operating conditions, the switch turns on when the stylus is in contact with or within proximity to the touch-sensitive device's surface. In an embodiment, the stylus is configured such that it constantly modulates a signal, and the state of the switch can change one or more properties of the signal, such as its frequency, amplitude, or the like. Constant modulation allows the stylus to not only be used when it is in contact with the surface of the touch-sensitive device, but also when it is slightly above as well, providing a “hover” capability. In an embodiment, the stylus can use an accelerometer to detect motion, and thereby instigate modulation. In an embodiment, the stylus can detect grip of a user to instigate modulation. Variations in the way the modulation can be started and/or stopped are within the scope and spirit of this disclosure, and will be apparent to persons of skill in the art in view of this disclosure.

In an embodiment as shown in FIG. 3C, circuitry (e.g., a modulator or variable circuit) is placed in the coupling path, and such circuitry may be used to modulate the coupled signal. The modulation may be accomplished by varying at least one parameter, e.g., amplitude, frequency, phase, code, time or any combination thereof. For example, circuitry may also amplify the coupled signal by using a parametric amplifier. Other circuit configurations and parameter modulations will be apparent to one of skill in the art in view of this disclosure.

In an embodiment, touch sensors may operate in modes that determine how the stylus interacts with the touch detection signals of the touch sensitive device during a touch event. In an embodiment, the stylus interacts with the surface, and the coupling increases beyond the residual coupling that is present without the stylus. In an embodiment, the stylus interacts with the surface, and the coupling decreases to below the residual coupling. A semi-passive stylus may be used in touch detection systems regardless of whether the coupling increases or the coupling decreases as a result of the stylus interaction.

In an embodiment, frequency components (such as but not limited to the sidebands) caused by the modulation can only increase, but cannot decrease, in the presence of the stylus, because, those components do not exist without the modulation. Therefore, in an embodiment where the coupling of a PCAP surface when touched decreases below the residual coupling, increase in specific frequency components can be associated with stylus-induced modulation, thereby enabling discrimination between stylus and touch input.

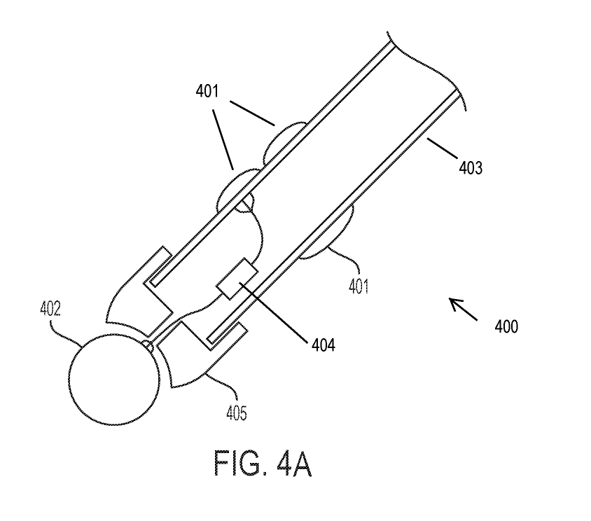

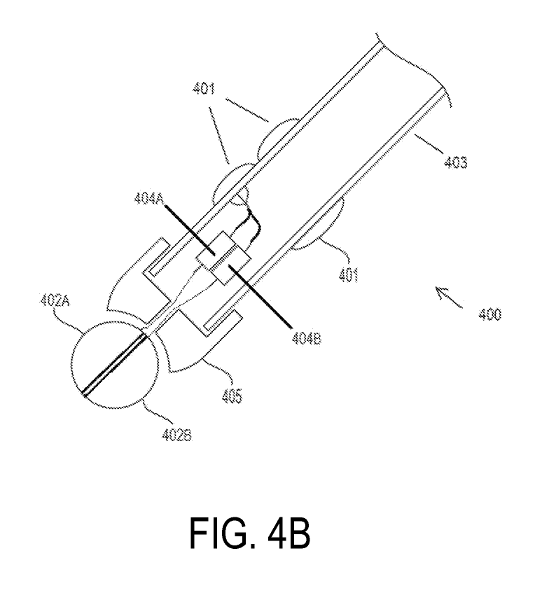

In an embodiment, where connection to the environmental ground plays a role in coupling changes, that coupling may be largely affected by the user's body and how he or she holds the stylus or tangible. In an embodiment, circuitry (e.g., a modulator, switching means, or variable circuit) may be placed between the user and the stylus or tangible nib in order to modulate this coupling. FIG. 4A shows an embodiment of a semi-passive stylus 400 that uses the user's body 401 to couple to the environmental ground. In an embodiment, the conductive nib component 402 of the stylus 400 may be directly connected to the conductive or highly dielectric body 403 of the stylus 400 so that a user's hand 401 is coupled to the nib component 402. By placing a circuit 404 between the stylus body 403 and nib 402 as in the depicted embodiment in FIG. 4A, this coupling can be modulated with low power to enable reliable discrimination between a given stylus and other simultaneously sensed touch input signals. An insulating section 405 may be placed between the nib 402 and, e.g., the conductive or highly dielectric body 403 of the stylus 400.

FIG. 4B shows an embodiment of a semi-passive stylus 400 that can use a user's body 401 to couple to environmental ground. A stylus body 403 supports a nib having a first nib component 402A and second nib component 402B. In an embodiment, the first nib component 402A and the second nib component 402B are connected to the conductive or highly dielectric body 403 of the stylus 400 via a variable circuit 404A, 404B. In such a configuration, variable circuits 404A, 404B control conductive coupling between a hand 401 and the two nib components 402A, 402B, respectively. By placing a first variable circuit (or a modulation component) 404A and a second variable circuit (or a modulation component) 404B between the stylus body 403 and the two nib components 402A, 402B as in the depicted embodiment in FIG. 4B, this coupling can be modulated with low power. By having first variable circuit 404A and a second variable circuit 404B vary in different ways, reliable discrimination between them may be achieved. In an embodiment, the first variable circuit 404A is connected to the first nib component 402A, and varies (or modulates) an electrical connection between the first nib component 402A and the elongated stylus body 403 or another conductive portion of the stylus that is in conductive contact with a user's hand 401. The second variable circuit 404B is connected to the second nib component 402B and varies a second electrical connection between the second nib component 402B and the elongated stylus body 403 or the user's hand 401. The variable circuits 404A, 404B are each adapted to vary an electrical connection between their respective nib component and the elongated stylus body 403 or another conductive portion of the stylus that is in conductive contact with a user's hand 401 in a way that is different—and distinguishable—from one-another. In an embodiment, the variable circuit 404A, 404B vary the respective electrical connections at a different rate. An insulating section 405 may be placed between the nib components 402A, 402B and, e.g., the conductive or highly dielectric body 403 of the stylus 400. In an embodiment, the stylus body 403 may be insulative, but a conductive region (not shown) may be present on its outer surface for interfacing a connection between the variable circuits 404A, 404B and a user's hand 401.

In an embodiment, the first nib component and one or more additional nib components are oriented—with respect to the touch-sensitive device—such that the first nib component is closer to the touch-sensitive device than any of the additional nib components when the stylus is in a first position and at least one of the additional nib components are closer to the touch-sensitive device than the first nib component when the stylus is in a second position. In an embodiment, a variable circuit is connected to each of the additional nib components, and these variable circuits are each adapted to vary an electrical connection between their respective nib component and the elongated stylus body or another conductive portion of the stylus that is in conductive contact with a user's hand. In an embodiment, all of the variable circuits are implemented in one integrated circuit.

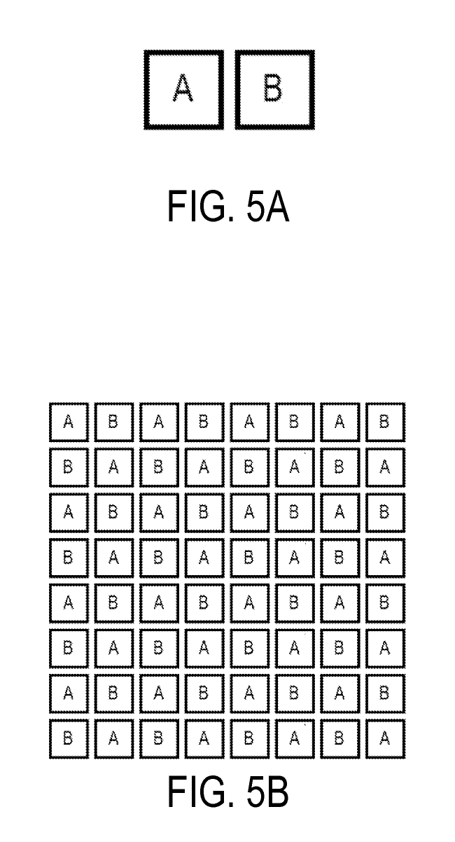

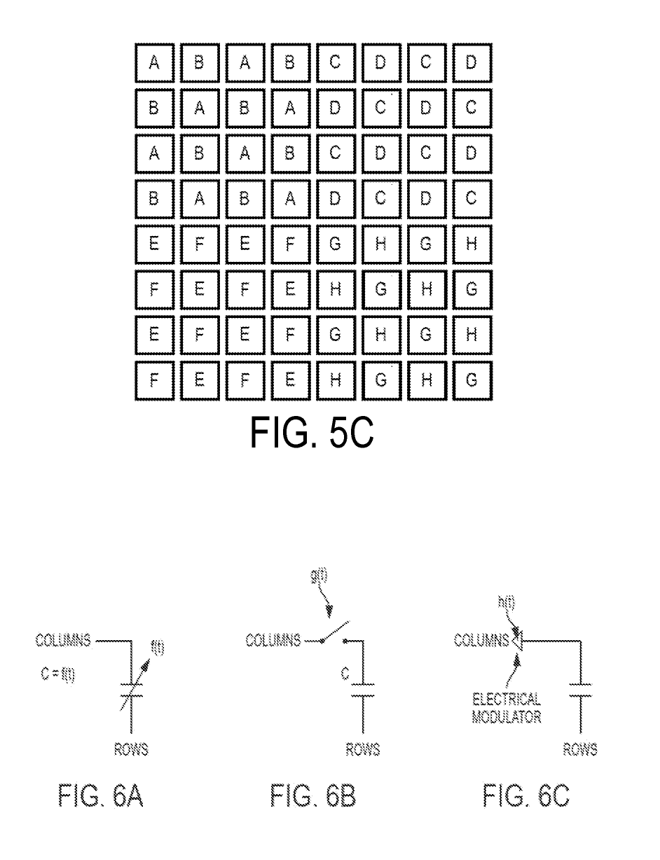

In an embodiment, where connection to the environmental ground plays less of a role, capacitive connection between portions of the stylus nib (or the part of the tangible comes into contact with the touch sensor) and the PCAP touch surface will be modulated. FIG. 5A shows an embodiment, where the nib is divided into two nib component (e.g., “A” and “B”) that are electrically isolated from one-another except as connected by a variable circuit (not shown). In an embodiment, although illustrated using “squares” the nib as a whole should be generally rounded. In an embodiment, shown in FIG. 5B, each of the nib components has multiple sub-components or elements, and the elements of the two nib components “A” and “B” are intermeshed or interleaved with one another. In an embodiment, elements of the two nib components are oriented such that at least some of each nib component will come into contact with the touch sensor. In an embodiment, the two nib components are electrically isolated (or insulated) from each other (e.g., one half is interconnected among the individual “A” sections, and the other half is interconnected among the individual “B” sections). In an embodiment, the two sections can be connected by a variable circuit. In an embodiment, a variable circuit connecting the two sections together, vary the connection in time in order to modulate the coupling between the stylus nib and the PCAP touch surface. In an embodiment, connecting “A” and “B” sections together increases the coupling capacitance. In an embodiment, disconnecting “A” and “B” sections decreases the coupling capacitance.

Turning now to FIG. 5C, eight nib components (e.g., “A,” “B,” “C,” “D,” “E,” “F,” “G,” and “H”) are shown. In an embodiment, each of the nib components are formed from a plurality of electrically connected sub-components. In the illustrated embodiment, the eight nib components are organized into four nib quadrants (e.g., a quarter of a hemisphere, or of a sphere), each nib quadrant comprising two nib components (i.e., A/B, C/D, E/F and G/H). In an embodiment, each nib component comprises eight sub-components or elements. The organization of nib components and sub-components may be designed to enhance sensitivity or angular or rotational sensing capabilities to the stylus. Variation to the number of nib components and sub-components, as well as the organization of each will be apparent to a person of skill in the art, in view of this disclosure. Thus, as would be understood by one of skill in the art in light of this disclosure, the nib can be divided into any number of sections, quadrants and/or other groupings. As would be further understood by one of skill in the art in light of this disclosure, FIGS. 5A-C are 2-dimensional schematics and an implementation of the disclosures herein may be accomplished with a curved or rounded nib.

Turning to FIGS. 6A-C, the effect of different types of variable circuits used on a multi-component nib are illustrated. According to FIG. 6A, in an embodiment, by altering the value of a parameter as a function of time, the signal coupled between a row and column can be affected by the stylus modulation to produce frequency components that were not present in the original signal. In an embodiment, coupling is the parameter. In an embodiment, because the amount of signal coupled from row to column is roughly proportional to the capacitance, modulating the capacitance effectively modulates the amplitude of the coupled signal. In an embodiment, if the capacitance is modulated as a sinusoid of frequency Fₘ, sidebands are added to the original coupled signal that are +Fₘ and −Fₘ away in frequency. In an embodiment, these sidebands can be detected by hardware, firmware, or software in the touch system and would identify the touch as being generated by a stylus/tangible that is modulating with frequency Fₘ. In an embodiment, different styli/tangibles can be identified by their different modulation waveforms, e.g., be in amplitude, frequency, phase, code, time, etc., or any combination of these.

Turning to FIG. 6B, in an embodiment, a stylus's or tangible's coupling (or a portion thereof) can be parametrically modulated through a nib to the touch panel by using an on and off switch. The use of the switch thereby creates a square-wave (or a wave approximating it) of amplitude modulation on the coupled stylus's or tangible's signal, and again creates frequency sidebands that can be used to distinguish a given stylus or tangible from another stylus or tangible and/or from a touch. Different embodiments can change in and out either series or parallel coupling capacitances.

Turning to FIG. 6C, in an embodiment, circuitry is inserted in the coupling path, and such circuitry may be used to modulate the coupled signal. The modulation may be, e.g., in amplitude, frequency, phase, code, or any combination thereof. In an embodiment, circuitry may also amplify the coupled signal by using a parametric amplifier.

In an embodiment, the stylus comprises an elongated stylus body and a first variable circuit operatively connected to each of two nib components located in the nib. The nib comprising the two nib components is adapted to interact with the touch detection signals present on the touch surface. Each of the two nib components is formed from a plurality of electrically connected sub-components. In an embodiment, the plurality of electrically connected sub-components of each nib component are interleaved with each other. In an embodiment, the two nib components are insulated from each other. The first variable circuit is adapted to vary a first electrical connection between the two nib components. In an embodiment, the nib further comprises two additional nib components which are insulated from each other. The second variable circuit is operatively connected to each of the two additional nib components, and is adapted to vary a first electrical connection between the two additional nib components. In an embodiment, each of the two additional nib components is formed from a plurality of electrically connected sub-components. In an embodiment, the plurality of electrically connected sub-components of each additional nib component are interleaved with each other.

In an embodiment, the nib has a plurality of nib components, and each of the nib components has its own modulation or switching hardware means. In an embodiment, the plurality of nib components are arranged such that multiple sections may come into contact with the touch surface when the nib is pressed against the surface. In an embodiment, when the stylus is in proximity to or presses the surface, there is a detectable change in the touch detector. In an embodiment, the angle of the stylus in relation to the touch surface determines the proximity between each of the plurality of nib components and the touch surface. In an embodiment, depending on the angle of the stylus in relation to the touch surface, the system detects different levels of modulated signal from each of the plurality of nib components. In an embodiment, the touch detector detects levels of modulated signal from each of the plurality of nib components in relation to the proximity of that nib component to the touch detector surface.

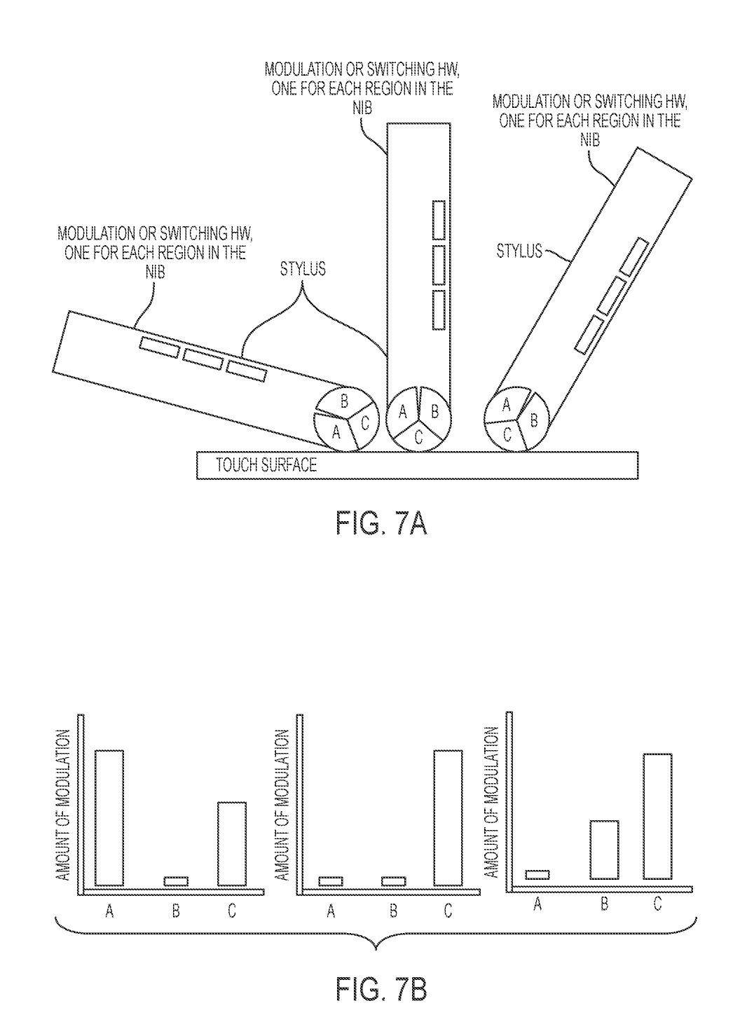

Turning to FIG. 7A, a stylus is shown with three nib components (for illustrative purposes). FIG. 7A further shows the stylus held in three different (two dimensional) orientations with respect to the touch surface. In an embodiment, given the relationship between the nib components of the stylus (each with unique modulations) and the touch surface, levels of modulation for each nib component in each of the three stylus positions shown in FIG. 7A are diagramed in FIG. 7B. As shown in FIG. 7B, where a nib component is placed closer or in contact with the touch surface, a higher modulation may result for that given nib component, when compared to a nib component that is farther away from the touch surface. Conversely, where the nib component is farther away from the touch surface, modulation produced by that nib component may be lower. Put differently, the amount of modulation produced by a given nib component is proportional (or at least correlated) to the respective nib component's proximity to the touch surface. Based on the modulations produced by the respective nib components, the stylus's angle, position and rotation with respect to the touch surface can be determined. As would be understood by one of ordinary skill in the art in light of this disclosure, the use of multiple differentiatable nib components may be employed in an embodiment where capacitive coupling to environmental ground is more, or less, important.

Also disclosed are methods for providing stylus identification information from a stylus nib in proximity to a touch-sensitive device wherein the stylus has a conductive region. In an embodiment, the method comprises gripping the stylus with a hand, at least a portion of the hand being conductively in contact with the conductive region; placing the nib of the stylus in proximity to a touch-sensitive device such that the nib interacts with the touch detection signals present on the touch surface; and varying an electrical connection between the nib and the conductive region, thereby providing positioning information from the stylus nib. In another embodiment, the method comprises gripping the stylus with a hand, at least a portion of the hand being conductively in contact with the conductive region; placing the nib of the stylus in proximity to a touch-sensitive device such that the nib interacts with the touch detection signals present on the touch surface; varying a plurality of electrical connections, each of the plurality of electrical connections being between one of the plurality of nib components and the conductive region, wherein the varying differs for at least two of the plurality of nib components.

While this illustration shows 2D orientation, it will be clear to one of ordinary skill in the art, in view of this disclosure, how this approach can be extended to sense tilt in multiple directions and even rotation of the stylus around its main axis.

The present systems and method are described above with reference to user input systems which provide a semi-passive stylus using parametric modulation. It is understood that each operational illustration may be implemented by means of analog or digital hardware and computer program instructions. Computer program instructions may be provided to a processor of a general purpose computer, special purpose computer, ASIC, or other programmable data processing apparatus, such that the instructions, which execute via a processor of a computer or other programmable data processing apparatus, implements the functions/acts specified. Except as expressly limited by the discussion above, in some alternate implementations, the functions/acts may occur out of the order noted in the operational illustrations.

While the invention has been particularly shown and described with reference to a preferred embodiment thereof, it will be understood by those skilled in the art that various changes in form and details may be made therein without departing from the spirit and scope of the invention.

What is claimed is:

1. A stylus for use in connection with a touch-sensitive device that generates touch detection signals proximate to its touch surface in connection with its touch detection operation, the stylus comprising:
a. elongated stylus body having a first end and a second end, the elongated stylus body being adapted for gripping in a hand;
b. nib supported at the first end of the elongated stylus body and insulated therefrom, the nib being adapted to interact with the touch detection signals present on the touch surface; and
c. first variable circuit operatively connected to the nib and to the elongated stylus body, the first variable circuit being adapted to vary a first electrical connection between the nib and the elongated stylus body.

2. The stylus of claim 1, further comprising:
a. power source operatively connected to the first variable circuit, providing power sufficient to operate the first variable circuit.

3. The stylus of claim 1, wherein the first electrical connection is varied by varying at least one parameter selected from the group consisting of: amplitude, time, frequency, phase and code.

4. The stylus of claim 1, wherein:
a. the nib comprises a first and second nib component insulated from one another, the first nib component and the second nib component being oriented with respect to the elongated stylus body, such that the first nib component is closer to the touch-sensitive device than the second nib component when the stylus is in a first position with respect to the touch-sensitive device, and the second nib component is closer to the touch-sensitive device than the first nib component when the stylus is in a second position with respect to the touch-sensitive device;
b. the first variable circuit being operatively connected to the first nib component; and
c. wherein a second variable circuit is operatively connected to the second nib component and the elongated stylus body, the second variable circuit being adapted to vary a second electrical connection between the second nib component and the elongated stylus body.

5. The stylus of claim 4, wherein the first variable circuit and the second variable circuit are part of a single integrate circuit.

6. The stylus of claim 4, wherein the first variable circuit is adapted to vary the first electrical connection in a first manner, and the second variable circuit is adapted to vary the second electrical connection in a second manner.

7. The stylus of claim 6, wherein the first manner is varying in amplitude at a first rate, and the second manner is varying in amplitude at a second rate.

8. The stylus of claim 1, wherein:
a. the nib comprises a first and second nib component insulated from one another, the first nib component and second nib component adapted to interact with the touch detection signals present on the touch surface;
b. the first variable circuit being operatively connected to the first nib component; and
c. wherein a second variable circuit is operatively connected to the second nib component and the elongated stylus body, the second variable circuit being adapted to vary a second electrical connection between the second nib component and the elongated stylus body.

9. A stylus for use in connection with a touch-sensitive device that generates touch detection signals proximate to its touch surface in connection with its touch detection operation, the stylus comprising:
a. stylus body having a first end and a second end, the stylus body adapted for gripping in a hand;
b. plurality of nib components supported at the first end of the stylus body and insulated therefrom, and from each other, each of the plurality of nib components being adapted to interact with the touch detection signals present on the touch surface; and
c. variable circuit operatively connected to each of the plurality of nib components and to the stylus body, the variable circuit being adapted to vary an electrical connection between each of the plurality of nib components and the stylus body.

10. A stylus for use in connection with a touch-sensitive device that generates touch detection signals proximate to its touch surface in connection with its touch detection operation, the stylus comprising:
a. stylus body having a first end and a second end, and having an outer surface, the stylus body adapted for gripping in a hand;
b. conductive region supported by the stylus body, the conductive region being positioned proximate to the outer surface of the stylus body such that the conductive region can make contact with a hand gripping the stylus;
c. first nib component supported at the first end of the stylus body, the first nib component being adapted to interact with the touch detection signals present on the touch surface; and
d. variable circuit operatively connected to the first nib component and to the conductive region, the variable circuit being adapted to vary an electrical connection between the first nib component and the conductive region.

11. A method for providing stylus identification information from a stylus nib in proximity to a touch-sensitive device, the stylus having a conductive region, the method comprising:
gripping the stylus with a hand, at least a portion of the hand being conductively in contact with the conductive region;
placing the nib of the stylus in proximity to a touch-sensitive device such that the nib interacts with the touch detection signals present on the touch surface;
varying an electrical connection between the nib and the conductive region, thereby providing positioning information from the stylus nib.

12. A method for providing stylus identification and orientation information from a stylus nib in proximity to a touch-sensitive device, the stylus nib containing a plurality of nib components, the stylus having a conductive region, the method comprising:
gripping the stylus with a hand, at least a portion of the hand being conductively in contact with the conductive region;
placing the nib of the stylus in proximity to a touch-sensitive device such that the nib interacts with the touch detection signals present on the touch surface;
varying a plurality of electrical connections, each of the plurality of electrical connections being between one of the plurality of nib components and the conductive region, wherein the varying differs for at least two of the plurality of nib components.

13. A stylus for use in connection with a touch-sensitive device that generates touch detection signals proximate to its touch surface in connection with its touch detection operation, the stylus comprising:
a. elongated stylus body having a first end and a second end, the elongated stylus body being adapted for gripping in a hand;
b. nib supported at the first end of the elongated stylus body and insulated therefrom, the nib comprising two nib components and being adapted to interact with the touch detection signals present on the touch surface;
c. the two nib components being insulated from each other; and
d. first variable circuit operatively connected to each of the two nib components, the first variable circuit being adapted to vary a first electrical connection between the two nib components.

14. The stylus of claim 13, wherein each of the two nib components is formed from a plurality of electrically connected sub-components.

15. The stylus of claim 14, wherein the plurality of electrically connected sub-components of each nib component are interleaved with each other.

16. The stylus of claim 13, the nib further comprising:
a. two additional nib components;
b. the two additional nib components being insulated from each other; and
c. second variable circuit operatively connected to each of the two additional nib components, the second variable circuit being adapted to vary a first electrical connection between the two additional nib components.

17. The stylus of claim 16, wherein each of the two additional nib components is formed from a plurality of electrically connected sub-components.

18. The stylus of claim 17, wherein the plurality of electrically connected sub-components of each additional nib component are interleaved with each other.
